(19) United States
(12) Patent Application Publication
(10) Pub. No.: US 2015/0264139 A1
(43) Pub. Date: Sep. 17, 2015

(54) METHOD AND ELECTRONIC DEVICES FOR PERFORMING FUNCTIONS

(71) Applicant: Samsung Electronics Co., Ltd., Gyeonggi-do (KR)

(72) Inventors: Kwang Sub SON, Gyeonggi-do (KR); Su Ha Yoon, Seoul (KR); Won Suk Choi, Seoul (KR); Kwang Weon Park, Gyeonggi-do (KR); Ji Hyun Park, Gyeonggi-do (KR); Seok Jun Baek, Gyeonggi-do (KR); Sung Ho Son, Daegu (KR); Young Eun Han, Gyeonggi-do (KR)

(73) Assignee: Samsung Electronics Co., Ltd.

(21) Appl. No.: 14/644,848

(22) Filed: Mar. 11, 2015

(30) Foreign Application Priority Data
Mar. 11, 2014 (KR) 10-2014-0028489

(51) Int. Cl. H04L 29/08

(52) U.S. Cl. CPC H04L 67/125; H04L 67/1002

(57) ABSTRACT

A method for performing efficient function operations in a plurality of electronic devices is provided. The method includes determining, by a first electronic device, whether at least one function is performable in a second electronic device, determining a scheme of performing the at least one function based on a determination that the at least one function is performable in the second device, and allowing the at least one function to be performed in at least one of the first electronic device and second electronic device.

### PRIORITY

The present application claims priority under 35 U.S.C. §119(a) to Korean Patent Application Serial No. 10-2014-0028489, which was filed in the Korean Intellectual Property Office on Mar. 11, 2014, the entire disclosure of which is incorporated herein by reference.

### BACKGROUND OF THE INVENTION

1. Field of the Invention

The present invention relates generally to a method and electronic devices for performing functions, and more particularly, to a method used by electronic devices for performing efficient function operations in the electronic devices.

2. Description of the Related Art

As electronic devices, such as smart phones or tablets which provide various functions, are developed, a user uses various functions through the electronic devices. Besides smart phones or tablets, electronic devices supporting various functions may also include wearable devices such as smart watches or smart glasses (for example, Google glasses, etc.), e-book readers (for example, Kindle Fires, etc.) or smart TVs.

When a user uses multiple electronic devices supporting various functions, the multiple electronic devices redundantly perform a specific function with other electronic devices. Alternatively, even if the multiple electronic devices are not redundantly performing the specific function, it may be difficult for the multiple electronic devices to efficiently share and perform the specific function. Accordingly, use efficiency of the multiple electronic devices and battery use efficiency or resource operation efficiency of the multiple electronic devices becomes lowered.

### SUMMARY OF THE INVENTION

The present invention has been made to address at least the above mentioned problems and/or disadvantages and to provide at least the advantages described below.

An aspect of the present invention provides a method for performing efficient function operations in a plurality of electronic devices. The method includes determining, by a first electronic device, whether at least one function is performable in a second electronic device, determining a scheme of performing the at least one function based on a determination that the at least one function is performable in the second device, and allowing the at least one function to be performed in at least one of the first electronic device and second electronic device.

An aspect of the present invention provides a first electronic device. The first electronic device includes a communication module and a control module. The communication module is configured to establish a connection between a first electronic device and a second electronic device so that the first electronic device and the second electronic device can communicate with each other. The control module is configured to determine if at least one function is performable in the second electronic device and to determine whether performance scheme of the at least one function to be performed in at least one of the first electronic device and the second electronic device based on a determination that the at least one function is performable in the second device.

Another aspect of the present invention provides a method for performing efficient function operations in a plurality of electronic devices, the method includes determining, by a first electronic device, whether a scan function is performable in a second electronic device, determining a performance scheme of the scan function based on a determination that the scan function is performable in the second electronic device, and allowing at least a portion of the scan function to be performed in the second electronic device.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a diagram illustrating a network environment including an electronic device, according to an embodiment of the present invention;

FIG. 2 is a block diagram of an electronic device, according to an embodiment of the present invention;

FIG. 3 is a flowchart illustrating a process of performing function delegation, according to an embodiment of the present invention;

FIG. 4 is a flowchart illustrating a process of performance of function delegation, according to an embodiment of the present invention;

FIG. 5 is a signaling diagram illustrating a process of performance of function delegation, according to an embodiment of the present invention;

FIG. 6 is a signaling diagram illustrating a process of performance of a Bluetooth Low Energy (BLE) scan function, according to an embodiment of the present invention;

FIG. 7 is a signaling diagram illustrating a process of performance of a message transmitting and receiving function, according to an embodiment of the present invention;

FIG. 8 is a signaling diagram illustrating a process of performance of a call delivery function, according to an embodiment of the present invention;

FIG. 9 is a signaling diagram illustrating a process of performance of a call delivery function, according to an embodiment of the present invention;

FIG. 10 is a diagram illustrating function delegation between a plurality of electronic devices, according to an embodiment of the present invention; and

FIG. 11 is a data diagram illustrating a function delegation signal, according to an embodiment of the present invention.

### DETAILED DESCRIPTION OF EMBODIMENTS OF THE PRESENT INVENTION

Hereinafter, embodiments of the present invention are described in detail with reference to the accompanying drawings. Those of ordinary skill in the art will recognize that various changes and modifications of the embodiments described herein can be made without departing from the scope of the present invention. In addition, descriptions of well-known functions and constructions may be omitted for clarity and conciseness. The same reference symbols are used throughout the drawings to refer to the same or like parts.

It should be noted that various embodiments described below may be applied or used individually or in combination.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The expression “alternatively” used herein includes any and all combinations of enumerated words. For example, “A or B” may include A, B, or both A and B.

It will be understood that, although the terms first, second, etc. may be used herein to describe various elements, these elements should not be limited by these terms. For example, these terms do not limit sequence and/or importance of corresponding elements. These terms are only used to distinguish one element from another. For example, a first user device and a second user device are all but different user devices. For example, a first element could be referred to as a second element, and, similarly, a second element could be referred to as a first element, without departing from the scope of the present invention.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

The term “module” used herein may mean, for example, a unit including a combination of one or two or more of hardware, software, or firmware. The “module” may be interchangeably used with a term, for example, a unit, logic, logical block, component, or circuit. The “module” may be a minimum unit or a portion of unit of a component configured into one. The “module” may be a minimum unit or a portion of unit performing one or more functions. The “module” may be implemented mechanically or electronically. For example, the “module” according to the specification may include at least one selected from an application-specific integrated circuit (ASIC) chip, field-programmable gate arrays (FPGAs), and programmable-logic device which perform certain operations and are already known or to be developed.

The terminology used herein is for the purpose of describing particular embodiments only and is not intended to be limiting of the invention. It is to be understood that the singular forms “a,” “an,” and “the” include plural referents unless the context clearly dictates otherwise.

Unless otherwise defined, all terms used herein have the same meaning as commonly understood by one of ordinary skill in the art to which this invention pertains, and should not be interpreted as having an excessively comprehensive meaning or as having an excessively contracted meaning. If technical terms used herein are erroneous and fail to accurately express the technical idea of the present invention, it should be replaced with technical terms that allow person skilled in the art to properly understand. General terms used herein should be interpreted according to the definitions in the dictionary or in context and should not be interpreted as an excessively contracted meaning.

An electronic device according to the present invention may be a device including a communication function. For example, the electronic device may be embodied in the form of a smart phone, a tablet PC, a mobile phone, a video phone, an e-book reader, a desktop PC, a laptop PC, a netbook computer, a personal digital assistant (PDA), a portable multimedia player (PMP), an MP3 player, mobile medical equipment, a camera, or a wearable device (for example, glasses such as a head-mounted-device (HMD), electronic clothes, electronic bracelet, electronic collar, appcessory, electronic tattoo, or smart watch, etc.).

An electronic device may be embodied in the form of various medical devices (e.g., magnetic resonance angiography (MRA), magnetic resonance imaging (MRI), computed tomography (CT), camcorder, ultrasound imaging, etc.), a navigation device, a global positioning system (GPS) receiver, an event data recorder (EDR), a flight data recorder (FDR), an automotive infotainment device, marine electronic equipment (such as a gyro compass and marine navigation system, etc.), avionics, security equipment, an automotive head unit, an industrial or domestic robot, an automatic teller machine (ATM) in a financial institution, and point of sales (POS) in a store.

According to some embodiments, an electronic device may be embodied in the form of furniture or building/structure including a communication function, an electronic board, an electronic signature receiving device, a projector, or other measuring instruments (such as water, electricity, gas, or propagation measurement devices, etc.).

An electronic device may be a combination of one or more of the above-described various electronic devices. In addition, an electronic device may be a flexible device. Furthermore, it may be obvious to those skilled in the art that an electronic device may not be limited to the above-described devices.

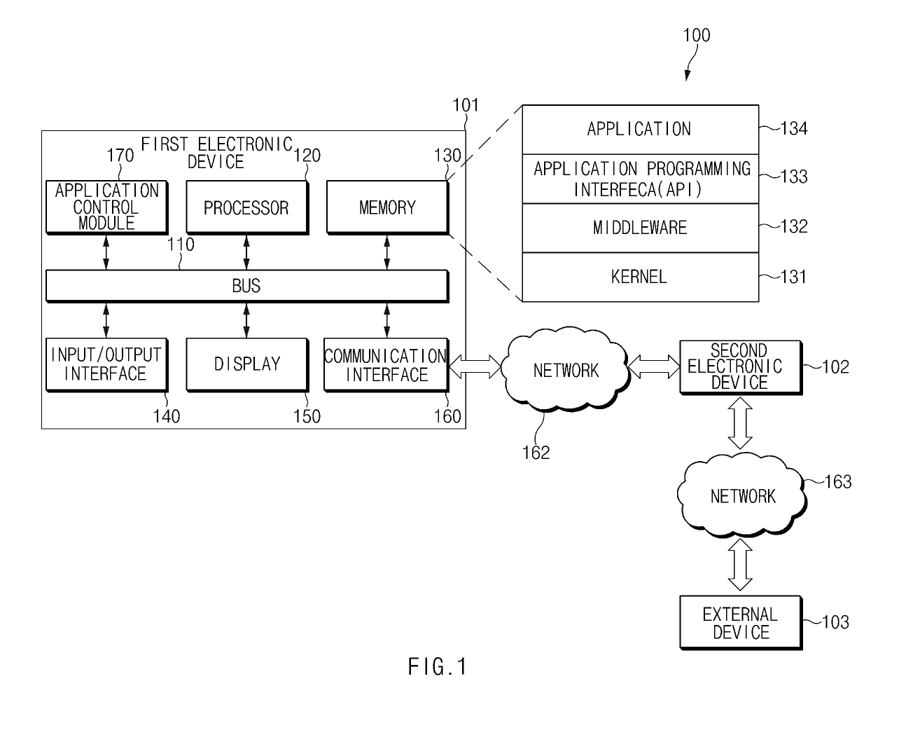

FIG. 1 is a diagram illustrating a network environment including an electronic device, according to an embodiment of the present invention.

Referring to FIG. 1, a first electronic device 101 includes a bus 110, a processor 120, a memory 130, an input/output interface 140, a display 150, a communication interface 160, and an application control module 170.

The bus 110 may be a circuit that connects the above-described elements to each other and delivers communication (for example, a control message) between the above-described elements.

The processor 120 receives, through the bus 110, commands from, for example, other elements (e.g., the memory 130, input/output interface 140, display 150, communication interface 160, or application control module 170), interprets the received commands, and performs operations or data processing according to the interpreted commands.

The memory 130 stores commands or data received from the processor 120 or other elements (e.g., the input/output interface 140, display 150, communication interface 160, or application control module 170), or created by the processor 120 or other elements. The memory 130 includes programming modules including, for example, a kernel 131, middleware 132, an application programming interface (API) 133, and an application 134. Each of the above-described programming modules may be configured with software, firmware, hardware, or a combination of at least two of them.

The kernel 131 controls or manages system resources (e.g., the bus 110, processor 120, or memory 130, etc.) used for executing operations or functions implemented in the programming modules, for example, the middleware 132, the API 133, or the application 134. In addition, the kernel 131 provides an interface allowing the middleware 132, the API 133, or the application 134 to access, control, or manage an individual element of the first electronic device 101.

The middleware 132 serves as a relay thereby allowing the API 133 or the application 134 to communicate with the middleware 132 and transmit and receive data. In addition, in relation to job requests received from the application 134, the middleware 132 performs controls (e.g., scheduling or load balancing) for the job requests by using a method of assigning a priority to at least one application from among the application(s) 134, which is able to use the system resource (e.g., the bus 110, processor 120 or memory 130, etc.) of the first electronic device 101.

The API 133 is an interface for controlling a function provided by the kernel 131 or the middleware 132, and may include at least one interface or function (e.g., a command) for, as an example, a file control, a window control, image processing or a character control.

The application 134 may include an SMS/MMS application, an email application, a calendar application, an alarm application, a healthcare application (e.g., an application for measuring an exercise amount or a blood sugar level), or an environment information application (e.g., an application providing atmospheric pressure, humidity, or temperature information). Additionally or alternatively, the application 134 may be an application related to information exchange between the first electronic device 101 and an external electronic device (e.g., a second electronic device 102 or external device 103). The application related to the information exchange may include, for example, a notification relay application for delivering designated information to the external electronic device, or a device management application for managing the external electronic device.

For example, the notification delivery application may include a function of delivering, to the external electronic device 102 or 103, notification information created by other applications (e.g., the SMS/MMS application, email application, healthcare application or environment information application, etc.) of the first electronic device 101. Additionally or alternatively, the notification delivery application may receive the notification information, for example, from the external device and provide it to a user. The device management application may manage (e.g., install, delete, or update), for example, functions for at least a portion of the external electronic device communicating with the first electronic device 101, applications operating in the external electronic device or services (e.g., call service or messaging service) provided in the external electronic device. The functions may include, for example, turning on/off of the external electronic device (or a portion of component) or adjustment of brightness (or resolution) of a display of the external device.

The application 134 may include an application designated according to attributes (e.g., a kind of electronic device) of the external electronic device. For example, when the external electronic device is an MP3 player, the application 134 may include an application related to playback of music. Similarly, in case where the external electronic device is mobile medical equipment, the application 134 may include an application related to health management. The application 134 may include at least one of an application designated in the first electronic device 101 and an application received from the external electronic device.

The input and output interface 140 delivers commands or data input from the user through an input/output device (e.g., a sensor, keyboard, or touch screen) of the first electronic device 101 to the processor 120, the memory 130, the communication interface 160 or the application control module 170 through, for example, the bus 110. For example, the input/output interface 140 may provide data for user's touch input through a touch screen to the processor 120. In addition, the input/output interface 140 may output, through the input/output device (e.g., a speaker or display), commands or data received from the processor 120, the memory 130, the communication interface 160, or the application control module 170 through, for example, the bus 110. For example, the input/output interface 140 may output voice data processed through the processor 120 to the user through the speaker.

The display 150 displays various types of information (e.g., multimedia data or text data, etc.) to the user.

The communication interface 160 provides communication between the first electronic device 101 and other electronic devices 102 or 103). For example, the communication interface 160 may be connected to a network 162 through wireless or wired communication and communicate with other electronic devices. The wireless communication may be provided from, for example, wireless fidelity (Wi-Fi), Bluetooth® (BT), near field communication (NFC), GPS, or cellular communication (e.g., long term evolution (LTE), LTE-advanced (LTE-A), code division multiple access (CDMA), wideband CDMA (WCDMA), universal mobile telecommunications system (UMTS), WiBro or global system for mobile communications (GSM). The wired communication may be provided from, for example, universal serial bus (USB), high definition multimedia interface (HDMI), recommended standard (RS)-232, and plain old telephone service (POTS).

The network 162 or 163 may be a telecommunications network. The telecommunications network may be a computer network, the internet, an internet of things, or a telephone network. A protocol (e.g., a transport layer protocol, a data link layer protocol, or the physical layer protocol, etc.) for communication between the first electronic device 101 and the external device may be supported by the application 134, the API 133, the middleware 132, the kernel 131, and the communication interface 160.

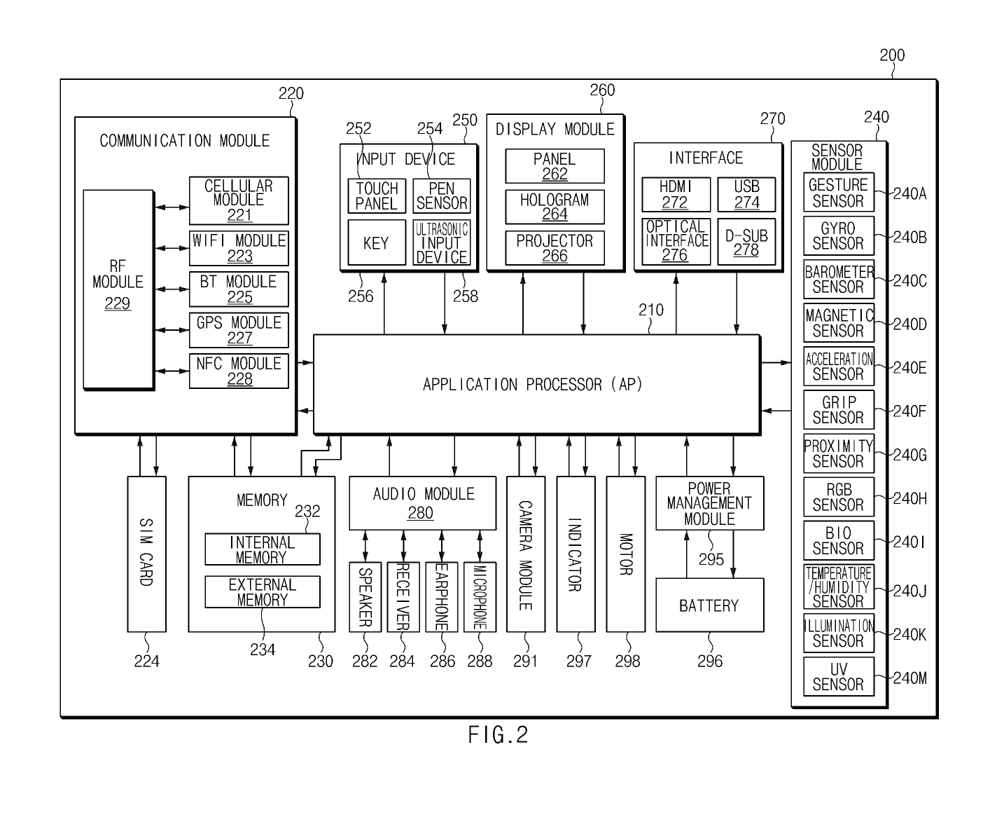

The application control module 170 processes at least a portion of information obtained from other elements (e.g., the processor 120, memory 130, input/output interface 140, or communication interface 160, etc.) and provides the processed information to the user in various ways. For example, the application control module 170 selects an application related to user information from among a plurality of applications stored in the memory 130 on the basis of user information received through the input/output interface 140. The selected application provides a service according to execution of a corresponding application to the user of the first electronic device 101 on the basis of data obtained from the second electronic device 102 or the external device 103 through the network 162 or 163. In addition, the application control nodule 170 selects and controls a designated application in order to obtain information from various sensors or elements mounted in the first electronic device 101, or to manipulate and process the obtained information. A configuration of the first electronic device 101 including the various sensors and/or modules will be described with reference to FIG. 2.

The first electronic device 101 may delegate a designated function to the second electronic device 102. The delegated function may correspond to at least one function performable in the first electronic device 101 or the second electronic device 102. For example, the first electronic device 101 may delegate detection (e.g., discovery or scan) for another electronic device (e.g., the external device 103) or detection for surrounding signals to the second electronic device 102.

The methods described hereinafter are described in terms of the first electronic device 101 delegating a designated function to the second electronic device 102, but a role of each electronic device is not so fixed. For example, the second electronic device 102 may be configured to delegate a designated function to the first electronic device 101.

The first electronic device 101 allows the second electronic device 102 to perform a function which is directly executable by the first electronic device 101. The first electronic device 101 may not execute the function directly and may delegate it to the second electronic device 102 in consideration of efficiency of performance (e.g., consideration of battery performance, communication performance, or operation performance, etc.). In addition, the first electronic device 101 allows the second electronic device 102 to perform a function that the first electronic device 101 does not directly perform. For example, although the first electronic device 101 does not include a certain communication module (e.g., a Wi-Fi module), when the corresponding module (e.g., the Wi-Fi module) is included in the second electronic device 102, the first electronic device 101 may request from or delegate to the second electronic device 102 to perform a function using the corresponding communication module.

The first electronic device 101 or the second electronic device 102 may correspond to a companion device such as a smart watch or a smart phone. However, the first electronic device 101 or the second electronic device 102 is not limited to the above-described device and may correspond to an arbitrary electronic device, such as the electronic devices described above, or a surrounding device capable of communicating with the corresponding electronic device.

In this specification, “delegate” may be understood in various meanings. For example, in various embodiments to be described later, the first electronic device 101 may delegate a designated function to the second electronic device 102 in various types. For example, the first electronic device 101 may operate such that the first electronic device 101 does not perform a delegated function until the delegated function is completed by the second electronic device 102. Alternatively, the first electronic device 101 may operate such that the designated function is shared and processed in the first and second electronic devices 101 and 102 for a certain time unit (e.g., in different time periods or for an equally/non-equally allocated time unit). For example, the first electronic device 101 performs a function in a 10 minute period, and the second electronic device 102 may perform the same function in a two minute period. Alternatively, the first electronic device 101 may operate such that a function may be alternately performed in the first and second electronic devices 101 and 102 (for example, the function is performed for 20 minutes in the first electronic device 101 and then performed for 40 minutes in the second electronic device 102).

As described above, the expression “delegate” may be understood as a type that a designated function is processed in cooperation with other electronic devices. Accordingly, in each embodiment, “delegate” may be understood as one or more applicable embodiments.

The first electronic device 101 requests, from the second electronic device 102, to perform a function of detecting various communication signals (e.g., a broadcasting message, advertising message, beacon signal, frequency signal of a designated band (e.g., a WCDMA or LTE band) or evolved multimedia broadcast multicast service (eMBMS) broadcast signal). Recognition of surrounding signals by the first electronic device 101 may cause significant battery consumption in the first electronic device 101 or may be inefficient compared to performance in the second electronic device 102. Alternatively, performance of a designated function in the first electronic device 101 may cause a change in a current state of the first electronic device 101. For example, the first electronic device 101 may require interrupting or stopping playback of a video which is currently playing or releasing a sleep state or a locked state. Here, the sleep state may mean one of a state where a screen of the first electronic device 101 is turned off while an application is totally completed, a state where an application processor does not operate, or a state where modules of a designated ratio or more among modules included in the electronic device 101 do not operate. When performance of the corresponding function by the second electronic device 102 is efficient (e.g., when the first electronic device 101 already uses a communication module designated for scanning, when the first electronic device 101 enters a sleep state, or when battery remnant of the first electronic device 101 is not greater than a reference value, etc.), the first electronic device 101 may request to perform the corresponding function from the second electronic device 102.

The second electronic device 102 provides, to the first electronic device 101, information that a specific function is available in the second electronic device 102 and/or information on an available function list in the second electronic device 102 when the specific function is available in the second electronic device 102 (e.g., when a smart phone and a smart watch are connected in a BT or tethering scheme). In this case, information on a network state, communication performance, battery remnant, or processor performance of the second electronic device 102 may be provided together. The first electronic device 101, having received the above-described information from the second electronic device 102, may delegate some functions (e.g., a message notification function, call function, location information receiving function, etc.) that are determined as performable in the second electronic device 102 in order for them to be performed in the second electronic device 102. Such a function delegation may be arbitrarily or automatically performed according to information previously defined or finally set in the first or second electronic device 101 and 102. Alternatively, a function to be performed in the first or second electronic device 101 and 102 may be determined in response to a user input when a selective user interface (UI) is provided to the user. For example, a list of functions performable in both the first and second electronic devices 101 and 102 may be displayed on at least one of the first and second electronic devices 101 and 102. The user may determine which device performs each function. For example, the user may set the first and second electronic devices 101 and 102 so that message reception and call functions are performed in the second electronic device 102 (e.g., a smart watch) and email confirmation is performed in the first electronic device 101 (e.g., a smart phone).

The second electronic device 102 may be connected to the first electronic device 101 through the network 162. The second electronic device 102 receives a request for performing at least one function from the first electronic device 101. The second electronic device 102 receives information necessary for performing a corresponding function from the first electronic device 101. For example, the second electronic device 102 receives a request for a Bluetooth low energy (BLE) scan on the external device 103 from the first electronic device 101. The second electronic device 102 receives information on the external device 103 which is a target of the BLE scan. The information received by the second electronic device 102 may be a list of various electronic devices configured in a smart home that are able to be connected to the first electronic device 101, or a list or attributes of electronic devices in which a machine to machine network (M2M) is implementable. The list or attribute information may include identification information (e.g., a serial number of the device) of the external device 103 that is connectable to the first electronic device 101, a type (e.g., a TV, smart phone, or headset) of the external device 103, a kind of service (e.g., whether a voice signal is possibly input/output, whether an image signal is possibly input/output, whether health care equipment corresponds to information on a service provider to which the device is registered, codec information supported by a speaker, a screen size, etc.) supported by the external device 103, and information on a device including a designated component. Such information may be provided through various communication channels (e.g., Wi-Fi) between the first and second electronic devices 101 and 102.

The second electronic device 102 may be connected to the external device 103 through the network 163. Alternatively, the second electronic device 102 may communicate with the external device 103 using a communication unit. The second electronic device 102 transmits a broadcasting signal to the surroundings and allows the external device 103, which is receiving the broadcasting signal, to broadcast or transmit to the second electronic device 102 information thereof (e.g., identification information or executable function information, etc.). The second electronic device 102 receives a signal from the external device 103 according to performance of a function requested from the first electronic device 101. For example, the second electronic device 102 receives device identification information broadcasted by the external device 103, similar to a TV receiving device identification information through a BLE scan.

The external device 103 may be connected to the second electronic device 102 through the network 163. The external device 103 may correspond to a device to be a target of a delegated function or a device necessary for performing a delegated function. For example, when the delegated function is BLE scan, the external device 103 may correspond to a TV or a smart phone which is to be a target of the BLE scan.

FIG. 2 is a block diagram of an electronic device 200, according to an embodiment of the present invention.

The electronic device 200 may make up, for example, an entire or a portion of the electronic device 101 or 102 illustrated in FIG. 1 The electronic device 200 includes at least one application processor (AP) 210 (e.g., the processor 120, or application control module 170), a communication module 220 (e.g., the communication interface 160), a subscriber identification module (SIM) card 224, a memory 230 (e.g., the memory 130), a sensor module 240, an input device 250 (e.g., the output interface 140), a display module 260 (e.g., the display 150), an interface 270 (e.g., the output interface 140), an audio module 280, a camera module 291, a power management module 295, a battery 296, an indicator 297, or a motor 298.

The AP 210 drives an operating system or an application program, controls a plurality of hardware or software elements connected thereto, and performs various data processing and operations including multimedia data. The AP 210 may be implemented with, for example, a system on chip (SoC). The AP 210 may further include a graphic processing unit (GPU).

The communication module 220 (e.g., the communication interface 160) performs data transmission and reception in communication between the electronic device 200 (e.g., the electronic device 101) and other electronic devices (e.g., the electronic device 102 or the external device 103) connected through a network. The communication module 220 includes a cellular module 221, a Wi-Fi module 223, a BT module 225, a GPS module 227, an NFC module 228, and a radio frequency (RF) module 229.

The cellular module 221 provides a voice call, a video call, a text messaging service, or an internet service, etc., through a communication network (e.g., LTE, LTE-A, CDMA, WCDMA, UMTS, WiBro, or GSM, etc.). In addition, the cellular module 221 identifies or authenticates an electronic device in a communication network by using, for example, a subscriber identification module (e.g., the SIM card 224). The cellular module 221 performs at least a portion of a function enabled by the AP 210. For example, the cellular module 221 performs at least a portion of multimedia control function.

The cellular module 221 includes a communication processor (CP). In addition, the cellular module 221 may be implemented with, for example, an SoC. Although, in FIG. 2, the elements such as the cellular module 221 (e.g., CP), the memory 230 and the power management module 295 are illustrated as separate components from the AP 210, the AP 210 may be implemented to include at least some (e.g., the cellular module 221) of the above-described elements.

The AP 210 or the cellular module 221 (e.g., CP) loads, on a volatile memory, commands or data received from at least one of a nonvolatile memory and other elements and process them. Furthermore, the AP 210 or the cellular module 221 stores, in the nonvolatile memory, data received from or created by at least one of other elements.

The Wi-Fi module 223, the BT module 225, the GPS module 227 or the NFC module 228 may respectively include, for example, a processor for processing data transmitted or received through the corresponding module. Although, in FIG. 2, the cellular module 221, the Wi-Fi module 223, the BT module 225, the GPS module 227 or the NFC module 228 are illustrated as separate blocks, at least some (e.g., at least two) of them may be included in a single integrated chip (IC) or an IC package. For example, at least some (e.g., a CP corresponding to the cellular module 221 and a Wi-Fi processor corresponding to the Wi-Fi module) of the processors respectively corresponding to the cellular module 221, the Wi-Fi module 223, the BT module 225, the GPS module 227 and the NFC module 228 may be implemented as one SoC.

The RF module 229 transmits or receives data, for example, an RF signal. The RF module 229 may include, for example, a transceiver, a power amp module (PAM), a frequency filter, or a low noise amplifier (LNA), etc. In addition, the RF module 229 may further include components, for example, a conductor or a wire for transmitting or receiving an electromagnetic wave in a free space in a wireless communication. In FIG. 2, although the cellular module 221, the Wi-Fi module 223, the BT module 225, the GPS module 227 and the NFC module 228 are illustrated as sharing one RF module 229, the cellular module 221, the Wi-Fi module 223, the BT module 225, the GPS module 227 and the NFC module 228 may transmit or receive an RF signal through a separate RF module.

The SIM card 224 may be a card including a subscriber identification module and may be inserted into a slot formed at a specific position of the electronic device 200. The SIM card 224 may be embedded in the electronic device 200 in a chip type or stored in a portion (e.g., an electronic SIM, virtual SIM, or soft SIM) of the electronic device 200 without any physical form. The SIM card 224 may include unique identification information (e.g., integrated circuit card identifier (ICCID)) or subscriber information (e.g., international mobile subscriber identity (IMSI)).

The memory 230 (e.g., the memory 130) includes an internal memory 232 and/or an external memory 234. The internal memory 232 may include at least one of, for example, a volatile memory (e.g., a dynamic RAM (DRAM), static RAM (SRAM), synchronous dynamic RAM (SDRAM) etc.) and a nonvolatile memory (e.g., a one time programmable ROM (OTROM), programmable ROM (PROM), erasable and programmable ROM (EPROM), electrically erasable and programmable ROM (EEPROM), mask ROM, flash ROM, NAND flash memory, NOR flash memory etc.).

The internal memory 232 may be a solid state drive (SSD).

The external memory 234 may further include a flash drive, for example, compact flash (CF), secure digital (SD), micro-secure digital (micro-SD), mini secure digital (mini-SD), extreme digital (xD), or a memory stick. The external memory 234 may be functionally connected to the electronic device 200 through various interfaces. The electronic device 200 may further include a storage device (or storage medium) like a hard drive.

The sensor module 240 measures a physical quantity or detects an operating state of the electronic device 200, and converts the measured or detected information into an electrical signal. The sensor module 240 includes, for example, a gesture sensor 240A, a gyro sensor 240B, an atmospheric pressure sensor 240C (e.g., barometer sensor), a magnetic sensor, 240D, an acceleration sensor 240E, a grip sensor 240F, a proximity sensor 240G, a color sensor 240H (e.g., RGB (red, green, blue) sensor), a biometric sensor 240I, temperature/humidity sensor 240J, an illumination sensor 240K (e.g., ambient light sensor), and an UV (ultra violet) sensor 240M. Additionally or alternatively, the sensor module 240 may include, for example, a e-nose sensor, an electromyography (EMG) sensor, an electroencephalogram (EEG) sensor, an electrocardiogram (ECG) sensor, an infra-red (IR) sensor, an iris sensor, or a fingerprint sensor, etc. The sensor module 240 may further include a control circuit for controlling at least one sensor therein.

The input device 250 includes a touch panel 252, a (digital) pen sensor 254, a key 256, or an ultrasonic input device 258.

The touch panel 252 recognizes a touch input, e.g., a capacitive type touch input, a pressure-sensitive type touch input, an infra-red ray type touch input, and a surface acoustic wave type touch input. The touch panel 252 may include a control circuit. In the instance where the touch panel recognizes touch input using a capacitive type touch input, physical contact or proximity recognition is possible. The touch panel 252 may further include a tactile layer. In this case, the touch panel 252 may provide tactile feedback to the user.

The (digital) pen sensor 254 may be implemented by using, for example, a method identical or similar to receiving user's touch input or a separate recognition sheet. The key 256 may include, for example, physical buttons, or optical keys or a keypad. The ultrasonic input device 258 may be a device capable of detecting a sound wave through a microphone 288 and confirming data in the electronic device 200 through an input tool generating an ultrasonic wave signal, and may be a device capable of wireless communication. The electronic device 200 may receive a user input from an external device (e.g., a computer or server) by using the communication module 220.

The display module 260 (e.g., the display 150) includes a panel 262, a hologram device 264, and/or a projector 266. The panel 262 may be, for example, a liquid crystal display or an active-matrix organic light-emitting diode (AMOLED). The panel 262 may be flexible, transparent, and/or wearable. The panel 262 may be configured as one module with the touch panel 252. The hologram device 264 shows a stereoscopic image in the air by using interference of lights. The projector 266 displays an image by projecting a light on a screen. The screen may be located, for example, inside or outside the electronic device 200. The display module 260 may further include a control circuit for controlling the panel 262, the hologram device 264, and/or the projector 266.

The interface 270 includes, for example, a high-definition multimedia interface (HDMI) 272, a universal serial bus (USB) 274, an optical interface 276, and/or a D-subminiature (D-sub) 278. The interface 270 may be included in, for example, the communication interface 160 illustrated in FIG. 1. Additionally or alternatively, the interface 270 may include, for example, a mobile high-definition link (MHL) interface, a secure digital (SD) card/multimedia card (MMC) interface, or an infrared data association (IrDA) specification interface.

The audio module 280 converts sound into an electrical signal, or vice versa. At least some elements of the audio module 280 may be included in, for example, the input/output interface 140 illustrated in FIG. 1. The audio module 280 processes sound information input from or output to, for example, a speaker 282, a receiver 284, an earphone 286 or the microphone 288.

The camera module 291 is a device configured to capture a still image or a video, and, may include at least one image sensor (e.g., a front side sensor or a rear side sensor), a lens, an image signal processor (ISP), or a flash (e.g., an LED or xenon lamp).

The power management module 295 manages power of the electronic device 200. The power management module 295 may include, for example, a power management integrated circuit (PMIC), a charger integrated circuit, or a battery gauge.

The PMIC may be embedded, for example, in an IC or inside a SoC. A charging scheme may be divided into a wireless and wired scheme. The charging IC may charge the battery and block inflow of over-voltage or over-current from a charger. The charging IC may include a charging IC for at least one of wired charging scheme or wireless charging scheme, which may be a magnetic resonance scheme, inductive coupling scheme, or microwave scheme. An additional circuit, for example, a coil loop, resonance circuit, or rectifier etc, may be further included for wireless charging.

The battery gauge may measure, for example, life of the battery 296, voltage, current or temperature while the battery 296 is charging. The battery 296 stores or generates electricity and supplies power to the electronic device 200 using the stored or generated electricity. The battery 296 may include, for example, a rechargeable battery or a solar battery.

The indicator 297 displays a specific state of the electronic device 200 or a portion thereof (e.g., the AP 210), for example, a booting state, message state or charging state, etc. The motor 298 converts an electrical signal into a mechanical vibration. The electronic device 200 may include a processing device (e.g., a GPU) for supporting a mobile TV. The processing device for supporting the mobile TV may process media data complying with specifications such as digital multimedia broadcasting (DMB), digital video broadcasting (DVB), or media flow, etc.

Each of the above-described elements according to various embodiments may be configured with one or more components, and a name of a corresponding element may vary according to a kind of electronic device. An electronic device according to various embodiments may be configured with at least one element among the above-described elements and some elements may be omitted or additional other elements may be further included. Furthermore, some of elements of the electronic devices described herein may be combined to be one entity and perform the same functions as those of corresponding elements before the combination.

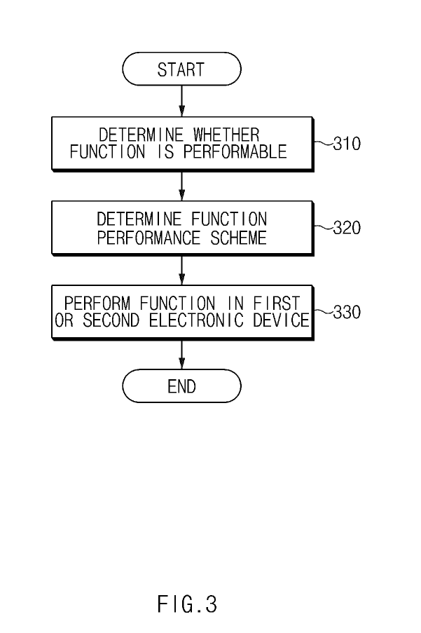

FIG. 3 is a flowchart illustrating a process of performing function delegation, according to an embodiment of the present invention.

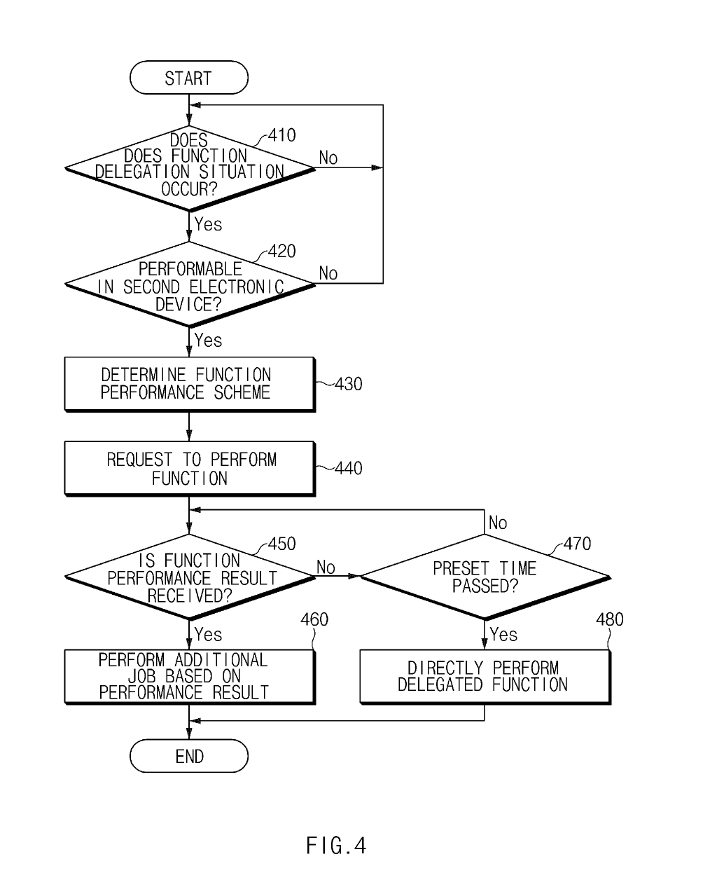

Referring to FIG. 3, at step 310, the first electronic device 101 determines whether the second electronic device 102 is capable of performing a function that is to be delegated. The first electronic device 101 determines whether the second electronic device 102 is capable of performing a function that is to be delegated based on device configuration information (e.g., whether a Wi-Fi chip is included) or operation state information (e.g., remaining battery capacity or communication quality) of the second electronic device 102. The step of determining will be described in greater detail with reference to FIG. 4.

The first electronic device 101 may correspond to a device (e.g., a device having a history of establishing a communication channel, establishing a communication channel, or able to establish a communication channel in correspondence to a control) able to interact with the second electronic device 102. For example, when the electronic device 101 is embodied in the form of a smart watch, the first electronic device 101 may interact in advance with the second electronic device 102, which is embodied in the form of a smart phone.

The first and second electronic devices 101 and 102 may share, in advance, a list of functions capable of being delegated through a pre-interaction process or information (e.g., a function performing target list, function performing time, function performing period or function performing condition, etc.) necessary for performing the function desired to be delegated. For example, the first and second electronic devices 101 and 102 may share information (e.g., BT pairing information or external device information) on the BLE scan function through pre-interaction.

At step 320, the first electronic device 101 determines a function performance scheme based on the determination at step 310. The first electronic device 101 determines a scheme that allows the delegated function to be performed only in the second electronic device 102 (e.g., frequency bands through which communication is possible are searched only by the second electronic device 102), or a scheme that allows some of the delegated function to be performed in the first electronic device 101 and the rest of the delegated function to be performed in the second electronic device 102 (e.g., some frequency bands are searched in the first electronic device 101 and the rest of the frequency bands are searched in the second electronic device 102). For example, when the BLE scan function is executable in the second electronic device 102, the first electronic device 101 may allow the function to be performed only in the second electronic device 102 but not to be performed in the first electronic device 101. Alternatively, the first electronic device 101 may allow the second electronic device 102 to perform BLE scan for only a portion of channels (a portion of bands among an available frequency band of a specific communication module) and may directly scan the rest of the channels (the rest of bands among the available frequency band of the specific communication module).

When requesting that the second electronic device 102 perform all of the delegated functions, the first electronic device 101 may select a performing scheme that deactivates the delegated function at the first electronic device 101, thereby preventing redundant performance of the delegated function. For example, the first electronic device 101 may allow only the second electronic device 102 to perform the BLE scan function and deactivate the BLE scan function for itself. By operating in such a way, the first electronic device 101 may increase efficiencies of battery and resource managements of the electronic devices 101, 102.

The first electronic device 101 allows at least one function to be simultaneously performed by the first electronic device 101 and the second electronic device 102, thereby increasing reliability of performance of the delegated function. The first electronic device 101 allows a delegated function to be performed by the second electronic device 102, while performing the delegated function in another period. For example, when requesting that the second electronic device 102 perform the BLE scan in a first period, the first electronic device 101 performs the BLE scan in a second period (which is different from the first period). In this case, the first electronic device 101 selects a scheme of performing the BLE scan in a different period (e.g., a longer period than the BLE scan period of the second electronic device 102) from the BLE scan period of the second electronic device 102, thereby reducing battery consumption and increasing the reliability of the scan result.

The first electronic device 101 requests that the second electronic device 102 perform a portion of the delegated function. That is, the first electronic device 101 shares and performs one function together with the second electronic device 102, thereby increasing efficiency of device use. For example, the first electronic device 101 determines to scan a first frequency band (e.g., 2.4 GHz) and allows the second electronic device 102 to scan a second frequency band (e.g., 5.0 GHz). The first electronic device 101 scans Wi-Fi direct social channels 1, 6, and 11 together with the second electronic device 102. When three advertising channels are included on the BLE scan, the first electronic device 101 may be set so that a first channel is scanned by the first electronic device 101, and a second channel, or the rest of the channels, is scanned by the second electronic device 102.

The first electronic device 101 determines a function performing scheme so that each band of 3G/LTE communication is allocated to a plurality of electronic devices, instead of full-scanning all the frequency bands by the first electronic device 101 in a roaming area. In addition, the first electronic device 101 determines a function performing scheme allocating communication channels to a plurality of electronic devices. The first electronic device 101 searches for a network signal of a first service provider and requests to search for a second service provider from the second electronic device 102.

When there are a plurality of second electronic devices 102, each capable of performing a delegated function, the first electronic device 101 delegates different functions to each of the electronic devices or allows each of the electronic devices to share and perform one function. For example, the first electronic device 101 requests from the second electronic device 102 to perform the BLE scan and from other electronic devices to perform Wi-Fi scan. Alternatively, for the BLE scan, the first electronic device 101 may request from the second electronic device 102 to scan a first channel and from other electronic devices to scan a second channel.

At step 330, the first and/or second electronic devices 101 102 perform a corresponding function according to the determined performing scheme. The first or second electronic devices 101 and 102 share a function performance result, which may be provided while the delegated function is being performed or after the delegated function has been performed.

The second electronic device 102 operates as if it were the first electronic device 101 instead of providing the function performance result to the first electronic device 101. For example, in a state where a battery state of the first electronic device 101 is not greater than a reference value, the second electronic device 102 to which the BLE scan function is delegated from the first electronic device 101 may be set to provide function performance result (e.g., information on an external device detected as capable of being connected to the first electronic device 101) to the first electronic device 101. At this point, although the first electronic device 101 is connected to the external device through the BLE, the connection may not be sufficiently maintained in consideration of the battery state of the first electronic device 101. In such a case, although the first electronic device 101 delegates the BLE scan function to the second electronic device 102, the performance result of the delegated function may also be provided to the second electronic device 102 as well as to the first electronic device 101. For example, the second electronic device 102 may establish (independently process instead of the first electronic device 101 or according to settings) BLE connection with an external device found through a scanning operation.

FIG. 4 is a flowchart illustrating a process of performance of function delegation, according to an embodiment of the present invention.

Referring to FIG. 4, at step 410, the Lust electronic device 101 determines whether a situation (e.g., a situation that efficiency of function performance is considered) that at least one function is to be delegated to the second electronic device 102 occurs. For example, the situation may include a case where the first electronic device 101 already uses a designated communication module, a case where the first electronic device 101 enters a sleep state, a case where the second electronic device 102 is located closer to the external device 103, which generates a signal, than the first electronic device 101, and a case where communication efficiency of the second electronic device 102 is higher than that of the first electronic device 101.

At this step, the first electronic device 101 sets a delegation processing situation on the basis of power consumption of a function desired to be delegated, function performance time, the kind of information obtainable through the delegation, the kind of application performing the delegated function, processor occupying ratio, RAM use ratio, location information, and a battery life comparison result of the first and second electronic devices 101 and 102. The first electronic device 101 may be set to automatically delegate a specific function under a certain condition. For example, when the battery life of the first electronic device 101 is not greater than a reference value, the first electronic device 101 is set to allow a portion of the delegated function to be automatically performed in the second electronic device 102. When the first electronic device 101 is executing a designated application (e.g., one of delegation occurrence application list), a portion of the delegated function of the first electronic device 101 may be automatically performed by the second electronic device 102. For example, when a TV remote control app is included in a delegation application list and the TV remote control app is executed, the first electronic device 101 may be set to automatically delegate the BLE scan function to the second electronic device 102.

At step 420, the first electronic device 101 determines whether the second electronic device 102 is able to perform a function that is to be delegated. The first electronic device 101 stores, in advance, information on a function to be performed in the second electronic device 102 or confirms whether the second electronic device 102 is able to perform a designated function (e.g., confirming by transmitting or receiving a message related to confirmation as to whether the second electronic device 102 is capable of performing a function that is to be delegated). The first electronic device 101 determines whether to delegate a specific function to the second electronic device 102 on the basis of previously stored information or information received in response to the request from the second electronic device 102.

The first electronic device 101 determines whether the second electronic device 102 is capable of performing a function that is to be delegated based on information relating to a device configuration of the second electronic device 102. For example, the second electronic device 102 provides the device configuration information relating to an inclusion of a designated communication module (e.g., a Wi-Fi chip) to the first electronic device 101. The first electronic device 101 determines if the second electronic device 102 is capable of performing a communication function using the corresponding communication module based on the device configuration information of the second electronic device 102.

The first electronic device 101 determines whether the second electronic device 102 is capable of performing a function that is to be delegated based on information on an operation state of the second electronic device 102. Here, the information on the operation state may include screen information (e.g., screen on/off state), application execution information (e.g., video playing), and whether to use a designated module (e.g., Wi-Fi chip in use). Alternatively, the first electronic device 101 determines whether the second electronic device 102 is capable of performing a function that is to be delegated by comparing a processor occupying ratio, a battery capacity, or a communication quality of the second electronic device 102 with designated reference values.

At step 430, the first electronic device 101 determines a function performing scheme. The first electronic device 101 determines a scheme that allows all the delegated functions to be performed by the second electronic device 102 or allows a portion of the delegated functions to be performed by the second electronic device 102. The first electronic device 101 selects a scheme that allows all the delegated functions to be performed by the second electronic device 102 and maintains a current state (e.g., a sleep state or an execution state of a designated application). For example, although delegating a message reception function to the second electronic device 102 and receiving a message during playing a video, the first electronic device 101 may continuously play video without creating a separate popup notification. The user may check the received message through the second electronic device 102 and continuously view the corresponding video through the first electronic device 101.

At step 440, the first electronic device 101 requests that the second electronic device 102 perform a function that is to be delegated.

At step 450, the first electronic device 101 confirms whether a result of performing the delegated function is received. For example, the first electronic device 101 receives device identification information relating to the external device 103 found through a scanning operation performed by the second electronic device 102. The first electronic device 101 receives a performance result according to a preset period or receives a performance result when a designated condition is satisfied (e.g., when a designated external device 103 is found, when there is a request for a designated application, when there is a request from the first electronic device 101, or when the second electronic device 102 is in a designated state (e.g., battery capacity of the second electronic device 102 is not greater than a reference value), etc.).

The second electronic device 102 provides to the first electronic device 101, in addition to a performance result of the delegated function, but also separate storage information related to the delegated function. For example, when storing a performance result of a BLE scan before requesting a BLE scan of the first electronic device 101, the second electronic device 102 provides the storage result to the first electronic device 101.

At step 460, when receiving the performance result of the delegated function, the first electronic device 101 performs additional processes based on the performance result. For example, when receiving the performance result of the scan function for the external device 103 (e.g., a TV) from the second electronic device 102, the first electronic device 101 requests a separate network formation from the external device 103 on the basis of the performance result.

At step 470, when not receiving the result of function performance from the second electronic device 102, the first electronic device 101 waits for reception of the performance result for a preset time period. When not receiving the performance result from the second electronic device 102 after the preset time period has passed, the first electronic device 101 cancels the function delegation operation to the second electronic device 102 and directly performs the function. In addition, the first electronic device 101 determines a connection state between the first electronic device 101 and the second electronic device 102 and attempts to reconnect when the connection is completed. When succeeding in the reconnection, the first electronic device 101 allows steps 410 to 440 to be automatically performed. In addition, the first electronic device 101 provides information on the corresponding situation (e.g., no response from the second electronic device 102, disconnection from the second electronic device 102, attempting to connect with the second electronic device 102, whether the delegated function is being performed by the second electronic device 102) through a user interface.

At step 480, as noted above, if it is determined that the preset time has expired, the first electronic device 101 directly performs the delegated function.

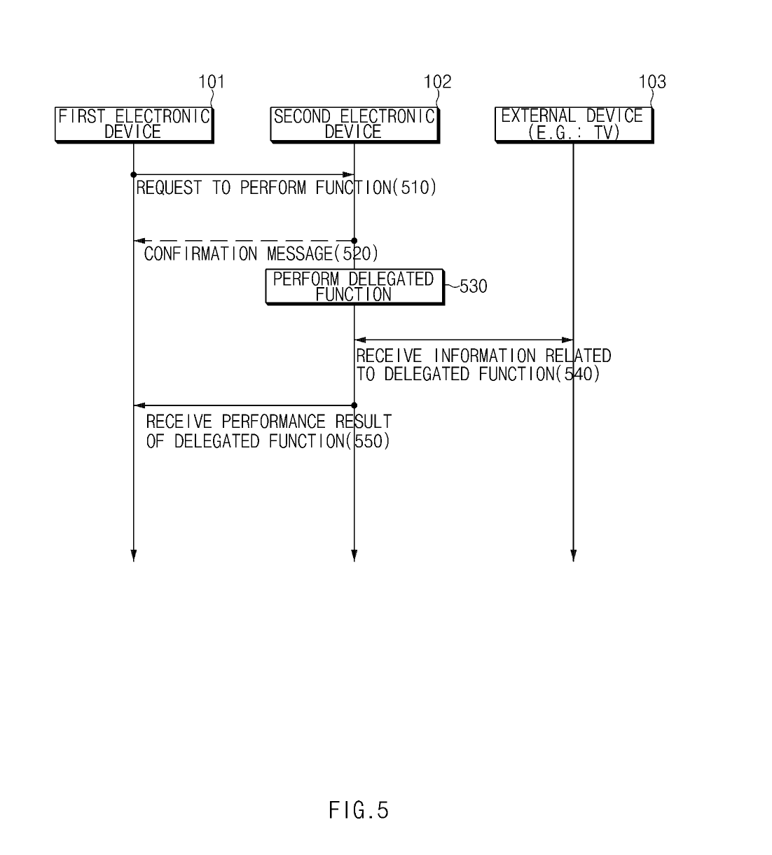

FIG. 5 is a signaling diagram illustrating a process of performance of function delegation, according to an embodiment of the present invention.

Referring FIG. 5, at step 510, the first electronic device 101 requests that the second electronic device 102 perform a function according to a pre-determined delegation. The first electronic device 101 provides information necessary for performing the delegated function to the second electronic device 102. For example, when requesting to search for surrounding devices from the second electronic device 102, the first electronic device 101 provides information on a list of searching target surrounding devices, a communication scheme to be used for the search, or search time to the second electronic device 102. For example, when requesting to search for the external device 103 from the second electronic device 102, the first electronic device 101 provides, to the second electronic device 102, information on searching target external devices (e.g., an external device list, kinds of external devices, or kinds of supported services), a communication scheme for searching (e.g., a BLE scan), or a time to search (e.g., stop searching after 10 minute).

At step 520, the second electronic device 102 transmits a confirmation message corresponding to the function performance request to the first electronic device 101. The second electronic device 102 performs the delegated function subsequent to transmitting the confirmation message to the first electronic device 101. When the second electronic device 102 is not capable performing the delegated function (e.g., the battery life is not greater than a reference value), the second electronic device 102 transmits an unable-to-perform message to the first electronic device 101. When receiving the unable-to-perform message, the first electronic device 101 determines whether to directly perform the delegated function.

At step 530, the second electronic device 102 performs the delegated function. For example, the second electronic device 102 scans the external device 103 or receives a message for the first electronic device 101.

The second electronic device 102 transmits an unable-to-perform message to the first electronic device 101 in case where a situation (e.g., a case where the battery life is not greater than a reference value) occurs while the second electronic device 102 is performing the delegated function, thereby preventing the second electronic device from completely performing the delegated function. The first electronic device 101 requests a result in response to receiving the unable-to-perform message, or search for another electronic device to perform the delegated function.

The first electronic device 101 transmits a performance stop message when the second electronic device 102 is no longer required to perform the delegated function any longer (e.g., the power cable is connected to the first electronic device 101 or the first electronic device 101 is requested to search for another electronic device for performing the delegated function). The second electronic device 102 stops performing the delegated function in response to the performance stop message and transmits a performance result to the first electronic device 101 indicating a percentage of completeness of the delegated function.

The first electronic device 101 cancels or temporarily stops function delegation according to a certain condition. For example, the first electronic device 101 requests to cancel or temporarily stop the delegated function from the second electronic device 102, when an operation state thereof is changed (e.g., decrease of a processor occupying ratio) or a result desired to obtain is already obtained.

The second electronic device 102 transmits a performance stop message or a temporary stop message for the delegated function under a certain condition. For example, the second electronic device 102 requests to cancel or temporarily stop the delegated function received from the first electronic device 101 when an operation state of the second electronic device 102 has changed (e.g., increase of a processor occupying ratio or battery life of not greater than a reference value). The first electronic device 101 waits for a predetermined time before directly performing the delegated function as a result of receiving the performance stop message or the temporary stop message. Alternatively, the first electronic device 101 reassigns the delegated function to another electronic device.

At step 540, the second electronic device 102 receives, from the external device 103, information related to performance of the delegated function while the second electronic device 102 is performing the delegated function. For example, the second electronic device 102 receives, from the external device 103, identification information on the external device 103, which is broadcasted through a BLE communication.

At step 550, the first electronic device 101 receives a performance result of the delegated function from the second electronic device 102. For example, the first electronic device 101 receives identification information on the external device 103 found through a scanning operation performed by the second electronic device 102.

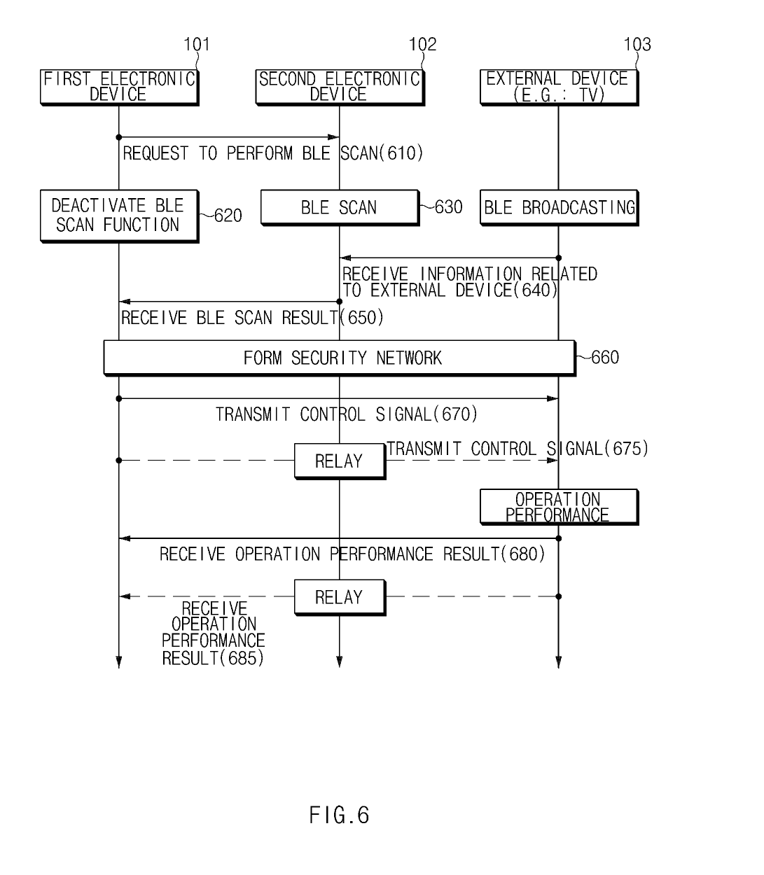

FIG. 6 is a signaling diagram illustrating a process of performance of a BLE scan function, according to an embodiment of the present invention.

Referring to FIG. 6, at step 610, the first electronic device 101 requests that the second electronic device 102 perform a BLE scan operation. The BLE scan may correspond to detecting a beacon signal in a surrounding of the electronic devices. In addition, the BLE scan may correspond to searching the surrounding electronic devices for the external device 103 equipped with a BLE communication function. Here, the external device 103 (e.g., TV) may correspond to a device periodically broadcasting information on the external device 103 by using the BLE communication. The information on the external device 103 may include information for identifying the device, such as a device ID, serial number, user account information, unique address of the device, or device type.

When the battery life of the first electronic device 101 is not greater than a reference value, or scan efficiency is increased by the second electronic device 102, the first electronic device 101 requests that the second electronic device 102 perform the BLE scan operation. When the battery life of the first electronic device 101 is not greater than a reference value, the first electronic device 101 may be set to automatically request a BLE scan from the second electronic device 102.

The first electronic device 101 provides a list of external devices to be scanned or information on search time at the same time when requesting that the BLE scan be performed by the second electronic device 102. For example, the first electronic device 101 provides, to the second electronic device 102, information that the external device 103 to be scanned is a TV and that the scanning operation is to be performed for 10 minutes while requesting that the second electronic device 102 perform the BLE scan.

At step 620, after delegating the BLE scan function to the second electronic device 102, the first electronic device 101 deactivates the BLE scan function from the first electronic device 101 in order to prevent redundant BLE scanning. The first electronic device 101 waits until a performance result of the BLE scan function is received from the second electronic device 102.

At step 630, the second electronic device 102 begins the BLE scan according to the function performance request received from the first electronic device 101. The second electronic device 102 searches for an external device 103 that is equipped with the BLE communication function.

At step 640, the second electronic device 102 receives identification information relating to the external device 103, which is broadcasted through BLE communication function.

The second electronic device 102 receives access security information from the external device 103. The access security information may correspond to an access code (e.g., a password) for forming a separate security network from the external device 103.

At step 650, when the BLE scan is completed, the second electronic device 102 transmits a performance result of the BLE scan to the first electronic device 101. The performance result of the BLE scan may include identification information on the external device 103 or the access security information.

At step 660, the first electronic device 101 directly forms a security network with the external device 103 on the basis of the performance result received from the second electronic device 102. For example, the first electronic device 101 requests to form a security network for the TV on the basis of identification information or access security information for the external device 103. The TV may confirm the received access security information and approve the security network formation. The second electronic device 102 forms a security network with the external device 103 on the basis of the delegation performance result separately from security network formed between the first electronic device 101 and the external device 103. The second electronic device 102 transmits a separate control signal to the external device 103 through the security network and receives an operation result for the control signal.

At step 670, the first electronic device 101 directly transmits a control signal to the external device 103 after the security network is formed. For example, the first electronic device 101 transmits a request for providing a discount coupon for products on advertising on the TV after the security network is formed.

At step 675, the first electronic device 101 transmits a control signal to the external device 103 through a relay provided by the second electronic device 102.

At step 680, the first electronic device 101 directly receives an operation performance result according to the control signal received from the external device 103. For example, the first electronic device 101 transmits, as the control signal, a request for providing a discount coupon for the products on advertising on the TV and downloads the discount coupon from the TV.

At step 685, the first electronic device 101 receives an operation performance result according to the control signal received from the external device 103 through a relay provided by the second electronic device 102.

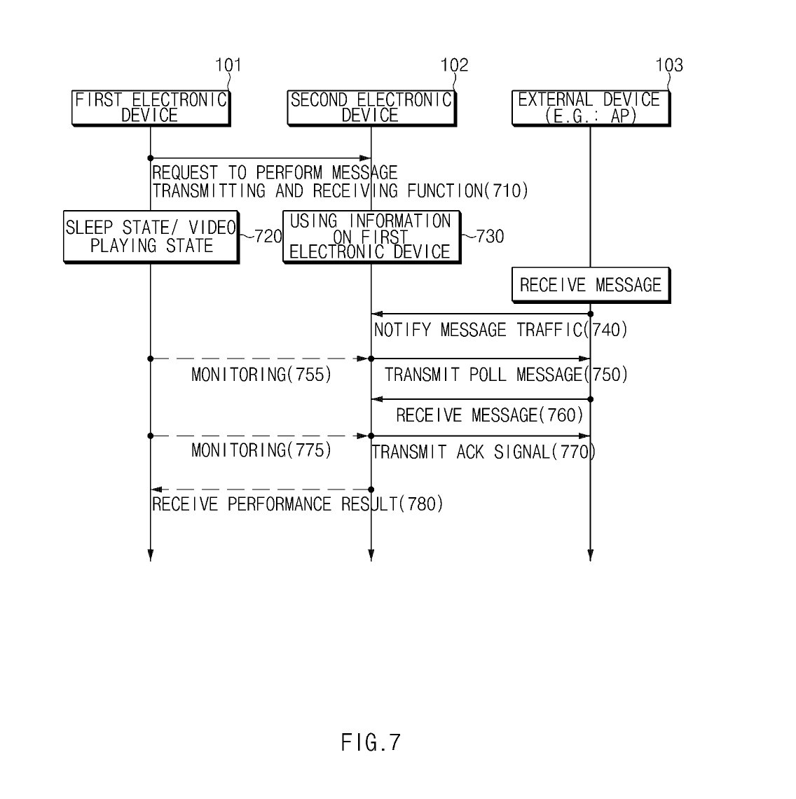

FIG. 7 is a signaling diagram illustrating a process of performance of a message transmitting and receiving function, according to an embodiment of the present invention.

Referring FIG. 7, at step 710, the first electronic device 101 requests (or delegates) to perform a message transmitting and receiving function from (to) the second electronic device 102. For example, when the first electronic device 101 is in a sleep state or a state of playing video in full screen, the first electronic device 101 requests to perform the message transmitting and receiving function through the second electronic device 102.

The first electronic device 101 provides terminal identification information on the first electronic device 101 to the second electronic device 102 at the same time as when requesting to perform the message transmitting and receiving function. Here, the terminal identification information may include a device identifier (e.g., a user ID or device serial number) or a network identifier of the first electronic device 101. The network identifier may include a MAC address. The first electronic device 101 provides an association ID or an encryption key between the first electronic device 101 and the external device 103 (e.g., an access point (AP)) to the second electronic device 102. The second electronic device 102 stores in advance terminal identification information on the first electronic device 101 through a pre-interaction process with the first electronic device 101. In this case, the second electronic device 102 may correspond to a companion device (e.g., smart watch) interactively operating with the first electronic device 101.

At step 720, the first electronic device 101 maintains the current sleep state or the video playing state after delegating the message transmitting or receiving function to the second electronic device 102. For example, even when receiving a message in the sleep state, the first electronic device 101 may not transition to a wake-up state (e.g., a processor driven state) and may receive the message through the second electronic device 102. In addition, in the video playing state (e.g., a state where the video is output in full screen), the first electronic device 101 may not be interrupted by a pop-up screen according to the message reception and may continuously play the video.

At step 730, the second electronic device 102 transmits or receives information relating to the first electronic device 101. The second electronic device 102 receives the information relating to the first electronic device by using the MAC address of the first electronic device 101. In this case, the external device 103 recognizes the second electronic device 102 as the first electronic device 101.

At step 740, the second electronic device 102 receives message traffic notification for the first electronic device 101 from the external device 103. For example, an AP, which is the external device 103, may notify the second electronic device 102 of an occurrence of message traffic for the first electronic device 101 through a traffic indicator map (TIM) of a beacon frame. Here the beacon frame may be a broadcasting frame that the AP periodically notifies surrounding electronic devices about a common channel of a network that it manages. The TIM may correspond to an information field that the AP transmits through the beacon frame.

At step 750, the second electronic device 102 transmits a confirmation message (e.g., a poll message) by using the MAC address of the first electronic device 101 in response to the message traffic notification received from the external device 103. In certain instances, the first electronic device 101 may transmit a separate confirmation message (e.g., a poll message) to the external device 103 while receiving the message traffic notification.

The first electronic device 101 monitors whether the second electronic device 102 performs a delegated function while maintaining the current operation state (e.g., a sleep state or a video playing state). While receiving the message traffic notification signal from the external device 103, the first electronic device 101 may cause a separate state change (e.g., a wake-up or a stop playing the video) and may wait for a preset time period. At step 755, when the second electronic device 102 transmits a poll message to the external device 103 in response to the receiving a corresponding notification signal, the first electronic device 101 determines if the message confirmation for the corresponding device is normally conducted and maintained in the current sleep state or video playing state. Conversely, when the second electronic device 102 does not generate a signal corresponding to the received corresponding notification signal for a preset time, the first electronic device 101 may transition from the current sleep state or video playing state and directly receive the corresponding message.

The second electronic device 102 periodically broadcasts a performance signal of the message transmitting and receiving function. The first electronic device 101 receives the corresponding broadcasting signal and monitors whether the second electronic device 102 is operating normally.

At step 760, the second electronic device 102 receives a message for the first electronic device 101 from the external device 103. The user may confirm the message through the second electronic device 102. The first electronic device 101 maintains a current operation state (e.g., a sleep state or a video playing state).

At step 770, the second electronic device 102 transmits an acknowledgement (ACK) signal of the message to the external device 103. At step 775, when the second electronic device 102 receives the message and transmits the ACK signal to the external device 103, the first electronic device 101 monitors the ACK signal.

At step 780, the first electronic device 101 receives a performance result of the message transmitting or receiving function from the second electronic device 102. The first electronic device 101 receives the performance result of the message transmitting or receiving function at a performance completion time preset by the user, a release time of the sleep state, or a time that the video playing is completed.

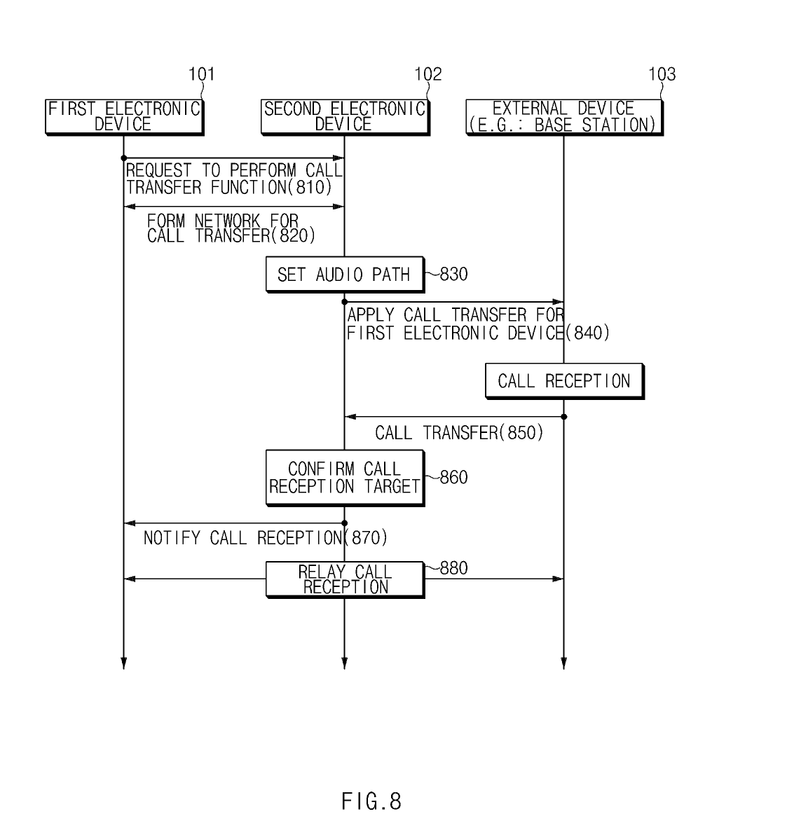

FIG. 8 is a signaling diagram illustrating a process of performance of a call delivery function, according to an embodiment of the present invention.

Referring to FIG. 8, at step 810, the first electronic device 101 requests to perform a call transfer function from the second electronic device 102, for example, when the battery life is not greater than a reference value or communication environment is worse than that of the second electronic device 102.

At step 820, the first electronic device 101 forms a network for call connection with the second electronic device 102. For example, the first electronic device 101 requests to perform pairing for Bluetooth communication from the second electronic device 102, and the second electronic device 102 accepts the request and forms a network for call connection. The first electronic device 101 provides a phone number, Universal Subscriber Identity Module (USIM) information, and terminal identification information to the second electronic device 102 through the network.

At step 830, the second electronic device 102 sets an audio path of the first electronic device 101. Here, the audio path may be a voice transfer path for call connection. For example, the second electronic device 102 sets an audio path through the microphone and speaker of the second electronic device 102 for calls directed towards the second electronic device 102, and sets an audio path through the microphone and speaker of the first electronic device 101 for calls directed towards the first electronic device 101 by using Bluetooth communication or Wi-Fi communication.

At step 840, the second electronic device 102 applies call transfer to a base station, e.g., the external device 103. The second electronic device 102 performs authentication for the call transfer to the base station based on a phone number and USIM information or the terminal identification information received from the first electronic device 101.

At step 850, the base station connects all incoming calls to the first electronic device 101 or the second electronic device 102 to the second electronic device 102.

At step 860, when receiving a call from the base station, the second electronic device 102 determines whether the call is for the first electronic device 101 or the second electronic device 102 based on the received phone number or USIM information. When the incoming call is directed towards the second electronic device 102, the second electronic device 102 receives the call according to the audio path through the microphone and speaker of the second electronic device 102.

At step 870, when the call is determined to be directed towards the first electronic device 101, the second electronic device 102 notifies the first electronic device 101 of the call reception.

At step 880, the second electronic device 102 relays call reception of the first electronic device 101 according to the preset audio path (e.g., a BT path or a Wi-Fi path).

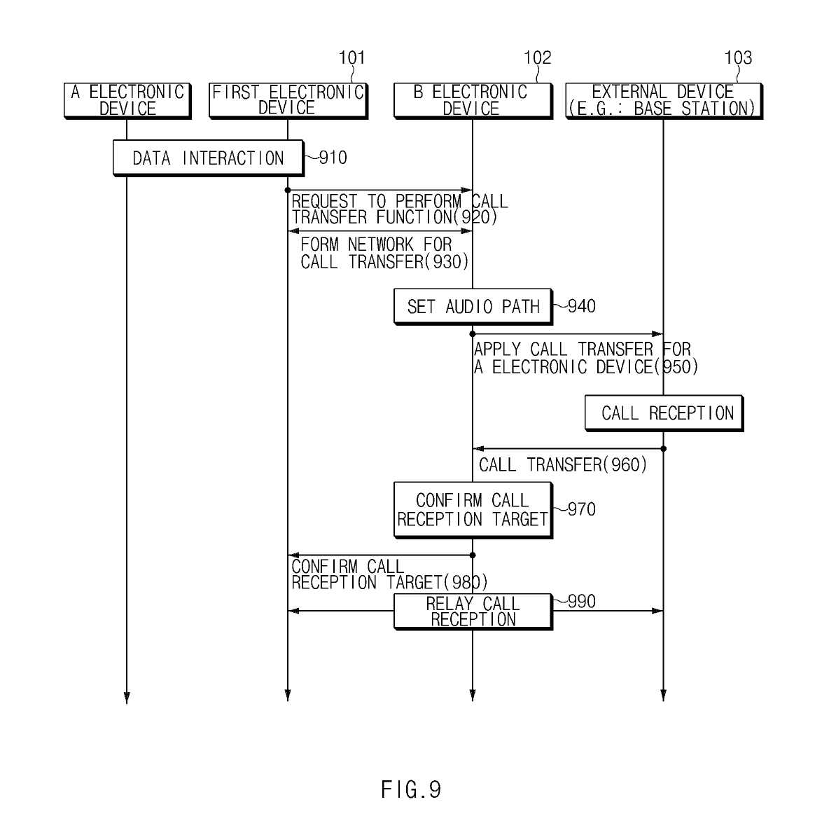

FIG. 9 is a signaling diagram illustrating a process of performance of a call delivery function, according to an embodiment of the present invention.

Referring to FIG. 9, at step 910, the first electronic device 101 interacts with an electronic device of a user “A” (hereinafter, “A” electronic device). The first electronic device 101 corresponds to a companion device (e.g., a smart watch) capable of calling along the preset audio path through a relay of the “A” electronic device, although directly not receiving an incoming call towards the “A” electronic device.

The first electronic device 101 stores a phone number, USIM information, and terminal identification information of the “A” electronic device through data interaction.

At step 920, the first electronic device 101 requests to receive an incoming call towards the “A” electronic device from an electronic device of a user “B” (hereinafter, “B” electronic device).

For example, when battery life of the “A” electronic device is not greater than a reference value (e.g., the battery life is not greater than 5%, or is in a discharged state) or a distance between the first electronic device 101 and the “A” electronic device is out of a preset range (e.g., 10 m or farther or distance that does not allow the first electronic device 101 and the “A” electronic device to communicate), the first electronic device 101 requests a call transfer function from the “B” electronic device.

Thereafter steps 930-990 are similar to steps 820-880 of FIG. 8.

At step 930, the first electronic device 101 forms a network for call connection with the “B” electronic device 102. The first electronic device 101 provides a phone number, USIM information, and terminal identification information of the “A” electronic device to the “B” electronic device.

At step 940, the “B” electronic device sets an audio path of the first electronic device 101.

At step 950, the B electronic device 102 applies call transfer for the “A” electronic device to a base station, e.g., the external device 103. The “B” electronic device performs authentication for the call transfer to the base station based on a phone number, USIM information or terminal identification information of the “A” electronic device, which is received from the first electronic device 101.

At step 960, the base station connects all incoming calls directed towards the “A” electronic device or the “B” electronic device to the “B” electronic device.

At step 970, when receiving a call from the base station, the “B” electronic device determines whether the incoming call is for the “A” electronic device or the “B” electronic device based on the received phone number or USIM information. When the incoming call is directed towards the “B” electronic device, the “B” electronic device receives the call according to the audio path through the microphone and speaker of the “B” electronic device.

At step 980, when the incoming call is determined to be directed towards the “A” electronic device, the “B” electronic device notifies the “A” electronic device of call reception.

At step 990, the “B” electronic device relays call reception of the “A” electronic device 101 according to the preset audio path (e.g., a BT path or a Wi-Fi path).

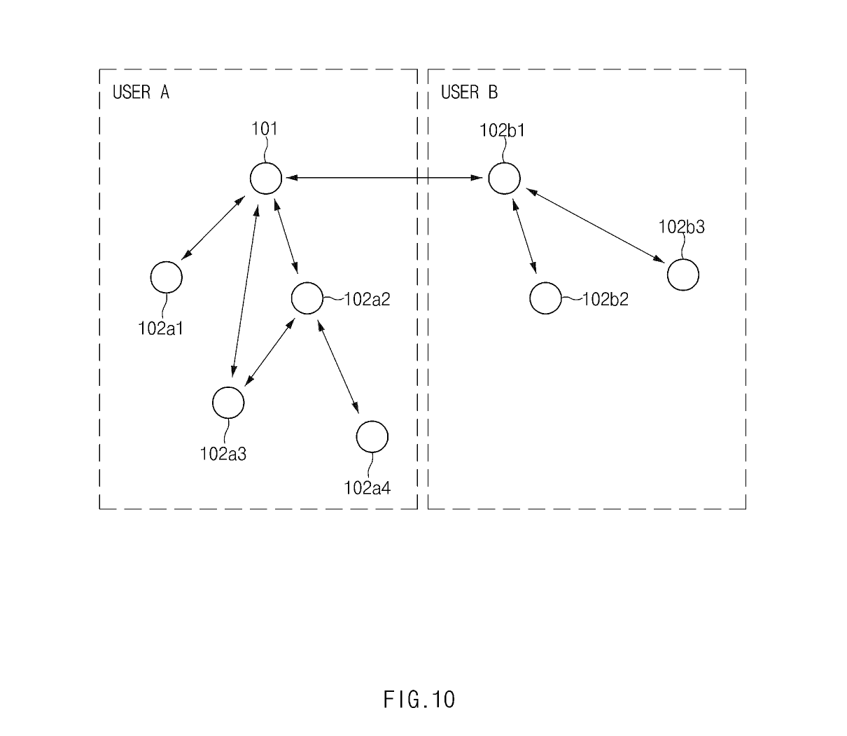

FIG. 10 is a diagram illustrating function delegation between a plurality of electronic devices, according to an embodiment of the present invention.

Referring to FIG. 10, the first electronic device 101 delegates a function to a plurality of second electronic devices 102. The first electronic device 101 or the second electronic devices 102 may have different performable functions. For example, the first electronic device 101 performs a function A or a function B. An electronic device 102a1 performs a function A or a function C. An electronic device 102b1 performs a function B or a function C. The first electronic device 101 collects information on functions that are able to be performed by each electronic device. The first electronic device 101 requests to transmit information on functions that are able to be performed by a corresponding device from each of the second electronic devices 102. The first electronic device 101 transmits a broadcasting message to surrounding devices and allows the second electronic device 102, having received the broadcasting message, to transmit information on performable functions. After receiving information on a performable function from the second electronic device 102, the first electronic device 101 performs a process of receiving authentication from the second electronic device when requesting to perform a designated function.

When the first electronic device 101 is able to delegate a function to the plurality of second electronic devices 102, the first electronic device 101 determines the second electronic device 102 to which the function is to be delegated according to a certain criterion. For example, when searching surrounding devices, the first electronic device 101 allows a second electronic device 102, determined as the farthest from the first electronic device 101, to perform the corresponding function. In various embodiments, the first electronic device 101 stores lists for devices able to perform functions to be delegated for each category or sub-category of the functions and stores information on conditions that the functions are able to be performed (e.g., a BLE scan possible from five to six).

The first electronic device 101 shares a function to be delegated with each of the plurality of second electronic devices 102 and allows them to perform the function. The first electronic device 101 delegates different functions to each electronic device and allows them to perform the functions. For example, the first electronic device 101 requests a BLE scan from the electronic device 102a1 and a Wi-Fi scan from the electronic device 102b1. In addition, the first electronic device 101 allows each electronic device to share and perform one function. For example, in the instance where a BLE scan is required, the first electronic device 101 requests a scanning operation for a first channel from an electronic device 102a1 and scan for a second channel from an electronic device 102a2.

The first electronic device 101 delegates (e.g., transfer of function delegation authority) function delegation itself to another electronic device. The first electronic device 101 does not directly determine a device that is a target of function performance and allows another electronic device to select a target to perform the function. The first electronic device 101 provides information on a determination criterion of a target to perform the function. For example, the first electronic device 101 delegates the scan function to the electronic device 102a1. The electronic device 102a1 directly performs the scan function or allows another surrounding electronic device 102b1 or 102b2 to perform the scan function according to a designated condition (e.g., communication quality is not lower than a reference value) determined by the first electronic device 101.

The first electronic device 101 confirms a performable function or whether to be in a performable state through a pre-interaction process for the second electronic device 102 of an identical user (e.g., the user A). The first electronic device 101 delegates a designated function to the second electronic device 102 of the identical user without a separate authentication process. On the contrary, the first electronic device 101 collects information for function delegation or performs an authentication process for function delegation for the second electronic device 102 of another user (e.g., user B).

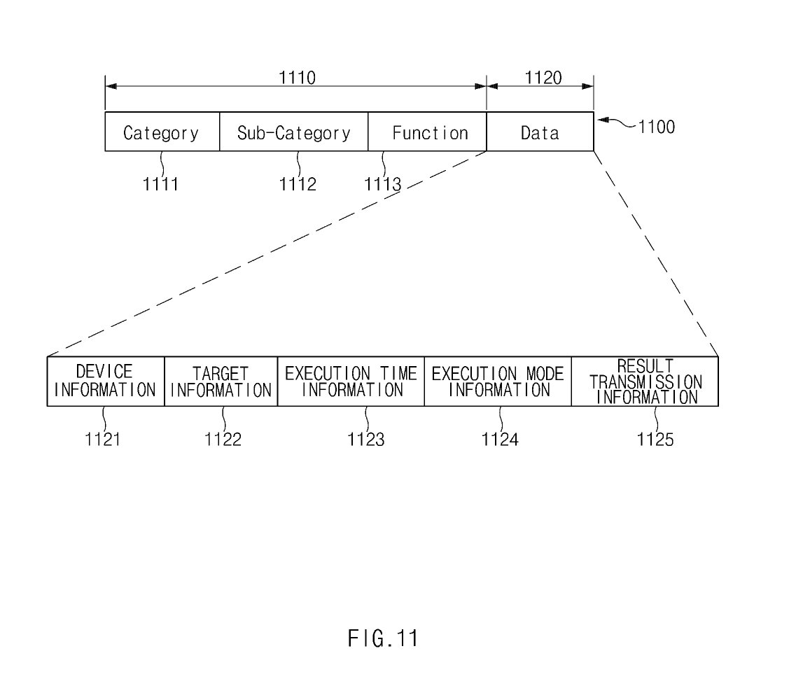

FIG. 11 is a data diagram illustrating a function delegation signal, according to an embodiment of the present invention.

Referring to FIG. 11, the first electronic device 101 transmits a function delegation signal 1100 to the second electronic device 102 and requests to perform a function. The function delegation signal 1100 may include information necessary for performing a function desired to be delegated. The function delegation signal 1100 includes an information field 1110 and a data field 1120.

The information field 1110 may include basic information related to a corresponding function. The information field 1110 includes a category field 1111, a sub category field 1112, and a function field 1113. However, the function delegation signal 1100 may include information other than the information illustrated in FIG. 11.

The category field 1111, the sub category field 1112, and the function field 1113 may be implemented in various types matched with one code according to all combinable types. For example, the category field 1111, the sub category field 1112, or the function field 1113 may be implemented in a type of codebook, command, or natural language, but is not limited thereto. The information field 1110 may not be divided into a category field 1111, a sub category field 1112, or a function field 1113 and may be implemented with one code matched with one function that is to be delegated.

The category field 1111 may correspond to a large classification item (e.g., a device connection, a type of multimedia, etc.) including a function that is to be delegates. The sub category field 1112 may correspond to a medium classification item (e.g., a BLE, a MP4, etc.) in a lower level than the category field 1111. The function field 1113 is a small classification item (e.g., scan, decoding, etc.) in a lower level than the sub category field 1112 and may display a function that is to be delegated. The second electronic device 102 confirms the category field 1111, the sub category field 1112, or the function field 1113, and transmits a message as to whether the function is performable in the second electronic device 102 to the first electronic device 101.

The data field 1120 may include information necessary for performing a delegated function. The data field 1120 includes device information 1121, target information 1122, execution time information 1123, execution mode information 1124, and result transmission information 1125, etc. However, the data field 1120 may include only some of the above-described information. For example, the data field 1120 may include channel information or time for scanning. The second electronic device 102 performs a function by using data pre-stored in the second electronic device 102 with respect to vacant fields from among the data field 1120.

The device information 1121 may include identification information (e.g., a MAC address, international mobile equipment identity (IMEI), a phone number, user account information, a universally unique identifier (UUID), etc.) of the first electronic device 101. The second electronic device 102 uses the identification information on the first electronic device 101 for performing the delegated function. For example, when the external device 103 does not respond to a request from the second electronic device 102, the second electronic device 102 uses the identification information on the first electronic device 101 and notifies the external device 103 of performance of a function associated with the first electronic device 101.

The target information 1122 corresponds to information on a target in which the delegated function is to be performed. The target information 1122 may include a surrounding cell list, a target list, a target identifier, a kind of target, a scan signal (e.g., a broadcasting beacon signal, pilot signal, eMBMS pilot signal, etc.), or a service identifier, etc.

The execution time information 1123 may include information related to time in which the delegated function is to be executed. The execution time information 1123 may include information related to a time required to perform the delegated function or performance period to perform the delegated function. The performance period may correspond to a performance period (e.g., to perform a scan at every 20 seconds) of the second electronic device 102 or a performance period (e.g., to perform a scan for 10 seconds in the first electronic device 101 and then a scan for 20 seconds in the second electronic device 102) associated with the first electronic device 101.

The execution mode information 1124 may include information on a scheme of performing the delegated function. For example, a first mode may correspond to scan in a scheme of monitoring surrounding signals, and a second mode may correspond to scan in a scheme of transmitting a query signal to surrounding electronic devices and receiving a response signal in response to the corresponding query signal. The second electronic device 102 confirms the execution mode information 1124 and performs a function according to the first or second mode.

The result transmission information 1125 may include information related to a scheme of transmitting a result of performing the delegated function or a scheme of using the result. The result transmission information 1125 may be set to instantaneously transmit a new performance result (e.g., finding a target device) or to transmit the result in a certain transmission period (e.g., transmitting the result in a two minute period). The result transmission information 1125 may be set to transmit a result even in a case where a portion of the scan target list is found.

The first electronic device 101 receives a performance result of the delegated function while the second electronic device 102 performs the delegated function. The first electronic device 101 transmits a request message for a proceeding result of the delegated function while the second electronic device 102 performs the delegated function. The second electronic device 102 provides, to the first electronic device 101, the function performance result until a request message is received from the first electronic device 101. The second electronic device 102 periodically transmits a performance result of the delegated function while performing the delegated function.

The result transmission information 1125 may include information on a scheme that the second electronic device 102 uses as a result of performing the delegated function. The second electronic device 102 uses the result according to a scheme (e.g., serving as a relay for the first electronic device 101 and the external device 103) preset by the first electronic device 101 or uses the result according to a scheme (e.g., direct transmission of a control signal from the second electronic device 102 to the external device 102) set by the second electronic device itself.

The second electronic device 102 transmits a confirmation message, a partial acceptance message, or an unable-to-perform message in response to the function delegation signal 1100. The second electronic device 102 transmits the confirmation message when performing all the delegated function. The first electronic device 101 enters a sleep state or performs an operation (e.g., a scan period change or scan frequency change) related to the delegated function when transmitting the confirmation message.

When receiving various delegated functions and attempting to perform some of the received delegated functions, the second electronic device 102 transmits the partial acceptance message. Alternatively, the second electronic device transmits the partial acceptance message even when able to perform only a portion of a delegated function. The first electronic device 101 transmits a delegation confirmation message or a delegation cancel message in response to the partial acceptance message. The second electronic device 102 transmits an unable-to-perform message when the second electronic device 102 is unable to perform the delegated function. The first electronic device 101 directly performs the function in response to the received unable-to-perform message or delegates the function to another electronic device.

According to various embodiments of the present invention, redundantly performed functions from among a plurality of electronic devices can be efficiently processed.

Furthermore, according to various embodiments of the present invention, performance of functions in a plurality of electronic devices can be optimized while efficiency of resource management and battery management of the electronic devices are enhanced.

In addition, according to various embodiments of the present invention, when an electronic device is in a designated state, a user's convenience in usability of the electronic device is enhanced by allowing a designated function to be performed in another electronic device while the designated state is continuously maintained.

A computer readable recording medium according to various embodiments may include instructions executable by a processor of a first electronic device, and the instructions allow the processor to perform efficient function operations in a plurality of electronic devices, the method includes determining, in a first electronic device, if at least one function is performable in a second electronic device, determining a scheme of performing the at least one function based on a determination that the at least one function is performable in the second device, and allowing the at least one function to be performed in at least one of the first electronic device and second electronic device.

While the present invention has been shown and described with reference to certain embodiments thereof, it should be understood by those skilled in the art that many variations and modifications of the method and apparatus described herein will still fall within the spirit and scope of the present invention as defined in the appended claims and their equivalents.

What is claimed is:

1. A method for performing efficient function operations in a plurality of electronic devices, the method comprising:
determining, in a first electronic device, whether at least one function is performable in a second electronic device;
determining a scheme of performing the at least one function based on a determination that the at least one function is performable in the second device; and
allowing the at least one function to be performed in at least one of the first electronic device and second electronic device.

2. The method according to claim 1, wherein determining whether the at least one function is performable in the second electronic device comprises:
receiving, from the second electronic device, at least one of information on a configuration of the second electronic device and information on a state at which the second electronic device is operating; and
determining whether the at least one function is performable in the second electronic device based on the received information.

3. The method according to claim 2, wherein the information on the configuration of the second electronic device includes at least one of a communication scheme that a communication module included in the second electronic device supports and information on a frequency band through which the communication scheme operates.

4. The method according to claim 2, wherein the information on a state at which the second electronic device is operating includes at least one of a battery life of the second electronic device, a charging state of the second electronic device, information on an application that is being executed in the second electronic device, and information on a processor occupying ratio of the second electronic device.

5. The method according to claim 1, wherein determining the scheme of performing the at least one function includes determining whether to allow all of or a portion of the at least one function to be performed in the second electronic device.

6. The method according to claim 5, wherein determining the scheme of performing the at least one function includes, when if it is determined that a portion of the function is to be performed in the second electronic device, determining that a remaining portion of the at least one function is to be performed in a third electronic device that is different from the first electronic device and the second electronic device.

7. The method according to claim 5, wherein determining the scheme of performing the at least one function includes, when it is determined that all the at least one function to be performed in the second electronic device, the at least one function is deactivated in the first electronic device.

8. The method according to claim 1, wherein determining the scheme of performing the at least one function includes determining whether the at least one function is to be performed with different periods in the first electronic device and the second electronic devices.

9. The method according to claim 1, wherein determining the scheme of performing the at least one function includes determining if the at least one function is to be performed alternately in the first and second electronic devices.

10. The method according to claim 1, wherein determining whether the at least one function is performable in the second electronic device is based on state information on the first electronic device.

11. The method according to claim 1, wherein determining whether the at least one function is performable in the second electronic device is performed when a battery capacity of the first electronic device is not greater than a reference value.

12. The method according to claim 1, wherein determining whether the at least one function is performable in the second electronic device is performed when a designated application is executed in the first electronic device.

13. The method according to claim 1, further comprising receiving a performance result of the at least one function that is performed in the second electronic device from the second electronic device.

14. The method according to claim 1, wherein the at least one function is a function of detecting a signal that is recognizable in one of the first electronic device and the second electronic device.

15. The method according to claim 1, further comprising monitoring if the at least one function is being performed in the second electronic device.

16. The method according to claim 15, wherein monitoring if the at least one function is being performed in the second electronic device includes receiving, by the first electronic device, a message broadcasted by the second electronic device.

17. A first electronic device comprising:
a communication module; and
a control module,
wherein the communication module is configured to establish a connection between the first electronic device and a second electronic device so that the first electronic device and the second electronic device can communicate with each other, and
the control module is configured to determine whether at least one function is performable in the second electronic device and to determine a performance scheme of the at least one function to be performed in at least one of the first electronic device and the second electronic device based on a determination that the at least one function is performable in the second device.

18. A method for performing efficient function operations in a plurality of electronic devices, the method comprising:
determining, by a first electronic device, whether a scan function is performable in a second electronic device;
determining a performance scheme of the scan function based on a determination that the scan function is performable in the second electronic device; and
allowing at least a portion of the scan function to be performed in the second electronic device.

19. The method according to claim 18, wherein the scan function is performed by using a plurality of channels having different frequency bands, and determining the performance scheme comprises scanning an external device by using at least one channel in the second electronic device and scanning the external device by using remaining channels in a device that is different from the second electronic device.

20. The method according to claim 19, wherein the device that is different from the second electronic device is one of the first electronic device and a third electronic device that is different from the first electronic device.
